(19) United States
(12) Patent Application Publication
(10) Pub. No.: US 2013/0164030 A1
(43) Pub. Date: Jun. 27, 2013

(54) PROCESS CARTRIDGE AND IMAGE FORMING APPARATUS

(71) Applicant: CANON KABUSHIKI KAISHA, Tokyo (JP)

(72) Inventors: Osamu Anan, Susono-shi (JP); Sadaaki Tani, Numazu-shi (JP)

(73) Assignee: CANON KABUSHIKI KAISHA, Tokyo (JP)

(21) Appl. No.: 13/719,987

(22) Filed: Dec. 19, 2012

(30) Foreign Application Priority Data
Dec. 21, 2011 (JP) 2011-280102

(51) Int. Cl. G03G 21/18

(52) U.S. Cl. CPC G03G 21/1821
USPC 399/111

(57) ABSTRACT

A process cartridge demountably mountable on an apparatus body of an image forming apparatus includes: an image carrying member; a first frame body configured to support the image carrying member; a developer carrying member configured to carry developer; a second frame body configured to support the developer carrying member; an urging member configured to urge the developer carrying member against the image carrying member; a holding member mounted between the first frame member and the second frame member and configured to hold the urging member so as not to cause the urging member to apply the urging force to the first frame member and the second frame member, and the urging member is configured to apply the urging force to the first frame member and the second frame member upon removal of the holding member.

### BACKGROUND OF THE INVENTION

1. Field of the Invention

The present disclosure relates to a process cartridge used for image forming apparatuses such as copying machines and printers which employ an electrophotographic system.

The process cartridge is a member including a developer carrying member and an image carrying member integrated into a cartridge, and is configured to be demountably mountable with respect to an apparatus body of the image forming apparatus (image forming apparatus body).

The image forming apparatus is configured to form an image on a recording medium.

2. Description of the Related Art

In the related art, an image forming apparatus using an electrophotographic image forming process employs a process cartridge system using an electrophotographic photosensitive member and a process unit performing an operation on the electrophotographic photosensitive member integrated into a cartridge, so that the cartridge is demountably mountable with respect to an image forming apparatus body. With the process cartridge system having this configuration, maintenance of the apparatus may be performed by users, and operability is markedly improved. Therefore, the process cartridge system of this type is widely used in the image forming apparatuses.

Such a process cartridge includes a photosensitive unit configured to hold a photosensitive drum as an image carrying member and a developing unit configured to hold a developing roller. The developing roller here is a developer carrying member configured to carry toner (developer) for developing a static latent image formed on the photosensitive drum. Then, a frame body of the photosensitive unit (first frame body) and a frame body of the developing unit (second frame body) are coupled by a round rod-shaped coupling pin so as to be rotatable with respect to each other.

In order to stabilize contact between the developing roller and the photosensitive drum to make a developing area to be developed by the developing roller and the photosensitive drum uniform, the developing roller is pressed against the photosensitive drum by an urging member which comes into contact with the first frame body and the second frame body. In other words, the process cartridge of this type is constantly urging the developing roller against the photosensitive drum via the urging member.

Therefore, when the state in which the developing roller is urged against the photosensitive drum continues for a long time, a surface layer of the developing roller is likely to be deformed along the surface of the photosensitive drum. Therefore, a separating member for separating the photosensitive drum and the developing roller from each other during delivery of the finished product after the completion of manufacture of the process cartridge until the user mounts the process cartridge on the image forming apparatus body is mounted on the process cartridge (for example, see Japanese Patent Laid-Open No. 2003-241621).

However, the process cartridge on which the separating member as described above is mounted is likely to be contained in a state in which the urging member (compression spring) is compressed more than at the time of normal image forming for a long time in the state after the shipping of the process cartridge. Accordingly, there is a concern that the urging member continuously applies an urging force on the first frame body and the second frame body in contact therewith larger than that during the normal image forming, and hence a contact portion of the frame body which is in contact with the urging member may be deformed. Once the contact portion of the frame body has been deformed, the frame body is not capable of receiving a stable load from the urging member when used by the user. Therefore, a pressing force applied on the developing roller against the photosensitive drum is not stabilized, and hence there is a probability that an image having a good quality cannot be obtained due to development failure.

### SUMMARY OF THE INVENTION

Accordingly, the present disclosure prevents an urging force with which an urging member urges a developer carrying member against an image carrying member from being applied on a process cartridge and prevents the process cartridge from being deformed.

According to a first aspect of the disclosed herein, there is provided a process cartridge demountably mountable on an apparatus body of an image forming apparatus including: an image carrying member on which a static latent image is formed; a first frame body configured to support the image carrying member; a developer carrying member configured to carry developer; a second frame body rotatably coupled to the first frame body and configured to support the developer carrying member; an urging member configured to apply an urging force to the first frame member and the second frame member so as to urge the developer carrying member against the image carrying member; a holding member demountably mounted between the first frame member and the second frame member, the holding member including a first contact portion coming into contact with one end portion of the urging member and a second contact portion coming into contact with the other end portion of the urging member and configured to hold the urging member so as not to cause the urging member to apply the urging force to the first frame member and the second frame member, wherein the urging member is configured to apply the urging force to the first frame member and the second frame member upon removal of the holding member.

According to another aspect of the disclosure, there is provided an image forming apparatus configured to form an image on a recording medium including: a transport device configured to transport the recording medium; and a process cartridge demountably mountable on an apparatus body of the image forming apparatus, wherein the process cartridge includes: an image carrying member on which a static latent image is formed; a first frame body configured to support the image carrying member; a developer carrying member configured to carry developer; a second frame body rotatably coupled to the first frame body and configured to support the developer carrying member; an urging member configured to apply an urging force to the first frame member and the second frame member so as to urge the developer carrying member against the image carrying member; a holding member demountably mounted between the first frame member and the second frame member, the holding member including a first contact portion coming into contact with one end portion of the urging member and a second contact portion coming into contact with the other end portion of the urging member and configured to hold the urging member so as not to cause the urging member to apply the urging force to the first frame member and the second frame member, wherein the urging member is configured to apply the urging force to the first frame member and the second frame member upon removal of the holding member.

Further features of the present disclosure will become apparent from the following description of exemplary embodiments with reference to the attached drawings.

### BRIEF DESCRIPTION OF THE DRAWINGS

FIG. 1 is an explanatory cross-sectional drawing illustrating a cartridge.

FIG. 2 is a general configuration drawing illustrating a color electrophotographic image forming apparatus.

FIG. 3 is an explanatory cross-sectional view illustrating the cartridge.

FIG. 4 is an explanatory perspective view illustrating a state before the cartridge is mounted on an image forming apparatus body.

FIG. 5A is a partial perspective view illustrating a cartridge in a state in which a developing roller and a photosensitive drum are in contact with each other.

FIG. 5B is a partial perspective view of the cartridge in a state in which the developing roller and the photosensitive drum are separated from each other.

FIG. 6 is an explanatory cross-sectional view illustrating the cartridge when being separated at the time of development.

FIG. 7A is an explanatory drawing illustrating an operation of a developing and separating member of the cartridge.

FIG. 7B is an explanatory drawing illustrating the operation of the developing and separating member of the cartridge.

FIG. 7C is an explanatory drawing illustrating the operation of the developing and separating member of the cartridge.

FIG. 8 is an explanatory drawing illustrating a configuration of a pressing spring holding member.

FIG. 9A is an explanatory drawing illustrating a demounting operation of the pressing spring holding member.

FIG. 9B is an explanatory drawing illustrating the demounting operation of the pressing spring holding member.

### DESCRIPTION OF THE EMBODIMENTS

Referring now to the drawings, embodiments of a process cartridge (hereinafter, referred to as “cartridge”) and a color electrophotographic image forming apparatus (hereinafter, referred to as “image forming apparatus”) will be described.

### General Configuration of Image Forming Apparatus

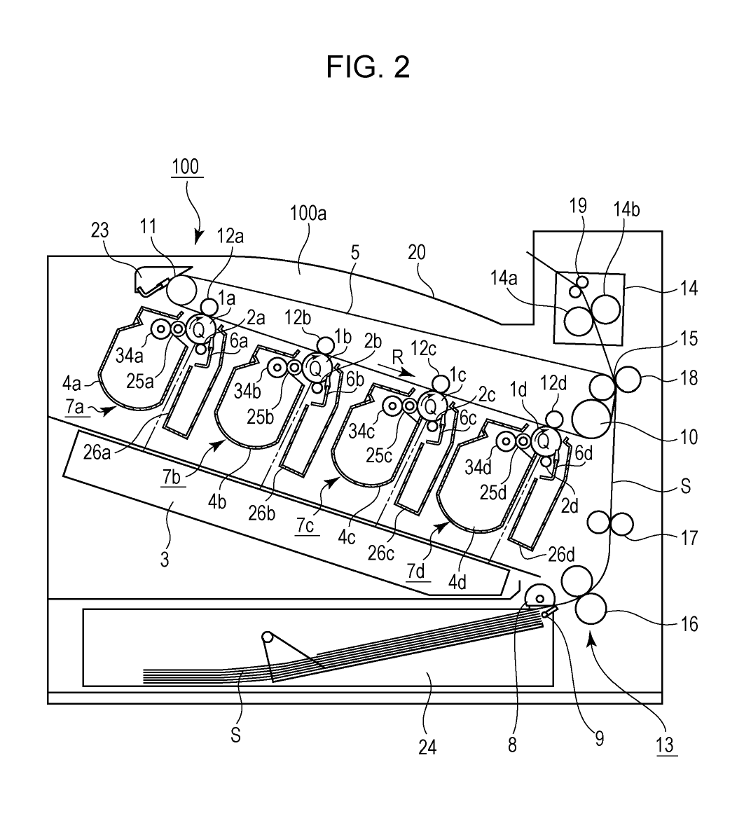

Referring now to FIG. 2, a general configuration of the image forming apparatus will be described. FIG. 2 is a general configuration drawing illustrating the image forming apparatus according to the embodiment.

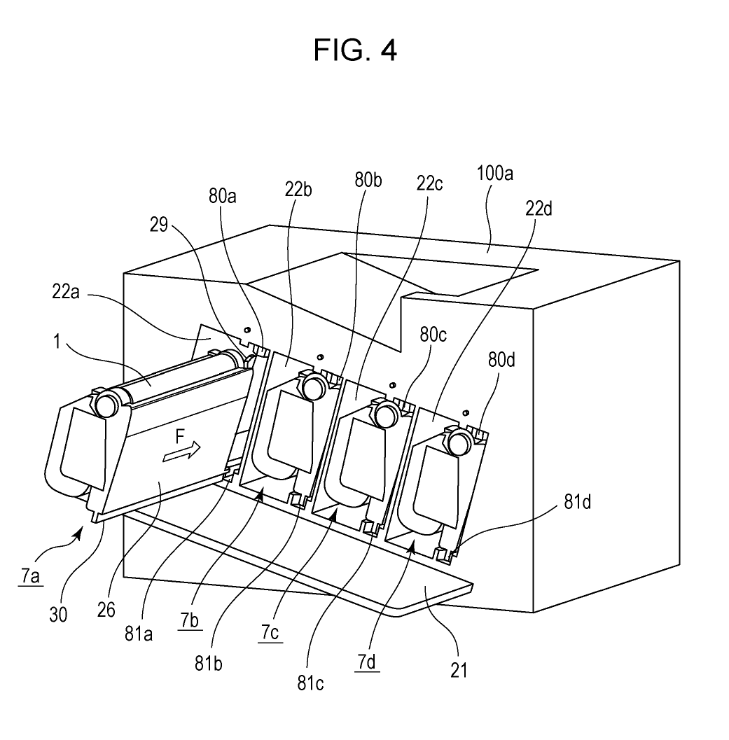

An image forming apparatus 100 illustrated in FIG. 2 includes four cartridges 7a, 7b, 7c, 7d (which may be collectively referred to as 7 for the sake of simplicity of description) arranged in a line so as to be inclined with respect to the horizontal direction. The four cartridges 7a, 7b, 7c, 7d are demountably mounted on mounting portions 22 (described later, see FIG. 4) provided on an apparatus body (image forming apparatus body) 100a of the image forming apparatus 100.

Here, the apparatus body 100a is a portion of the image forming apparatus 100 without the four cartridges 7a to 7d.

The cartridges 7a to 7d mounted on the mounting portions respectively include photosensitive drums 1a to 1d (which may be collectively referred to as 1 for the sake of simplicity of description). The electrophotographic photosensitive drum (hereinafter, referred to as “photosensitive drum”) 1 is an image carrying member formed with a static latent image formed on the surface thereof, and is configured to be driven to rotate in the direction indicated by the arrow Q in the drawing upon reception of a drive force from a driving member (motor), not illustrated, provided on the apparatus body 100a.

In the periphery of each of the photosensitive drums 1a to 1d, the following process units which act on the photosensitive drum are arranged in sequence in the direction of rotation thereof. In other words, one of the process units is constituted by cleaning members 6a to 6d (which may be collectively referred to as 6 for the sake of simplicity of description) configured to remove developer (hereinafter, referred to as “toner”) remaining on the surface of the photosensitive drum 1 after a toner image formed on the photosensitive drum 1 is transferred to an intermediate transfer belt 5. Another member of the process units is constituted by charging rollers 2a to 2d (which may be collectively referred to as 2 for the sake of simplicity of description) configured to charge the surface of the photosensitive drum 1 uniformly.

The cartridges 7a to 7d also include developing units 4a to 4d (which may be collectively referred to as 4 for the sake of simplicity of description) configured to develop the static latent image using the toner arranged thereon. The developing unit 4 develops the static latent image to form the toner image on the photosensitive drum 1.

Here, the photosensitive drum 1, the cleaning member 6, the charging roller 2, and the developing unit 4 are integrated into a cartridge and constitute the cartridge 7. The cartridge 7 is demountably mounted on the apparatus body 100a of the image forming apparatus 100 by users.

In addition, a scanner unit 3 configured to irradiate a laser beam on the basis of image information and form the static latent image on the photosensitive drum 1 and the intermediate transfer belt 5 on which four colors of toner images formed on the photosensitive drums 1a to 1d are transferred all together is arranged on the apparatus body 100a.

The intermediate transfer belt 5 is looped around a drive roller 10 and a tension roller 11. On the inside of the intermediate transfer belt 5, primary transfer rollers 12a to 12d (which may be collectively referred to as 12 for the sake of simplicity of description) are disposed so as to oppose the photosensitive drums 1a to 1d, respectively. A bias application unit (not illustrated) applies a transfer bias to the intermediate transfer belt 5.

The respective photosensitive drums 1a to 1d rotate in the direction indicated by the arrows Q, the intermediate transfer belt 5 rotates in the direction indicated by the arrow R, and a positive bias is applied to the primary transfer rollers 12a to 12d, whereby the toner images formed on the photosensitive drums 1a to 1d are primarily transferred to the intermediate transfer belt 5 in sequence. The four colors of toner images are transported to a secondary transfer portion 15 in a state of being superposed with one another the intermediate transfer belt.

A sheet S as a recording medium is transported by a transport device (transport unit) including a feeding unit 13 and a registration roller pair 17 synchronously with an image forming operation. The feeding unit 13 includes a feeding cassette 24 configured to accommodate the sheets S, a feed roller 8 configured to feed the sheets S, and a transport roller pair 16 configured to transport the fed sheets S. The sheets S accommodated in the feeding cassette 24 are subjected to press contact by the feed roller 8, are separated into individual sheets by a separation pad 9, and are transported one by one.

The sheets S transported from the feeding unit 13 are transported to the secondary transfer portion 15 by the registration roller pair 17. A positive bias is applied to the secondary transfer roller 18 at the secondary transfer portion 15. Accordingly, four colors of the toner images on the intermediate transfer belt 5 are secondary transferred to the transported sheet S.

After the toner images are transferred from the intermediate transfer belt 5 to the sheet S, the toner remaining on the intermediate transfer belt 5 is removed by an intermediate transfer belt cleaning device 23.

A fixing unit 14 as a fixer is configured to apply heat and pressure to the toner image formed on the sheet S and fix the toner image onto the sheet S. A fixing belt 14a has a cylindrical shape, and is guided by a belt guide member (not illustrated) on which a heating unit such as a heater is bonded. Then, the fixing belt 14a and a pressing roller 14b form a fixing nip with a predetermined press-contact force.

Then, the sheet S transported from the image forming portion and carrying an unfixed toner image formed thereon is heated and pressed at the fixing nip between the fixing belt 14a and the pressing roller 14b. Then, the unfixed toner image on the sheet S is fixed to the sheet S. Subsequently, the sheet S on which the toner image is fixed is discharged to a discharge tray 20 by a discharge roller pair 19.

### Cartridge

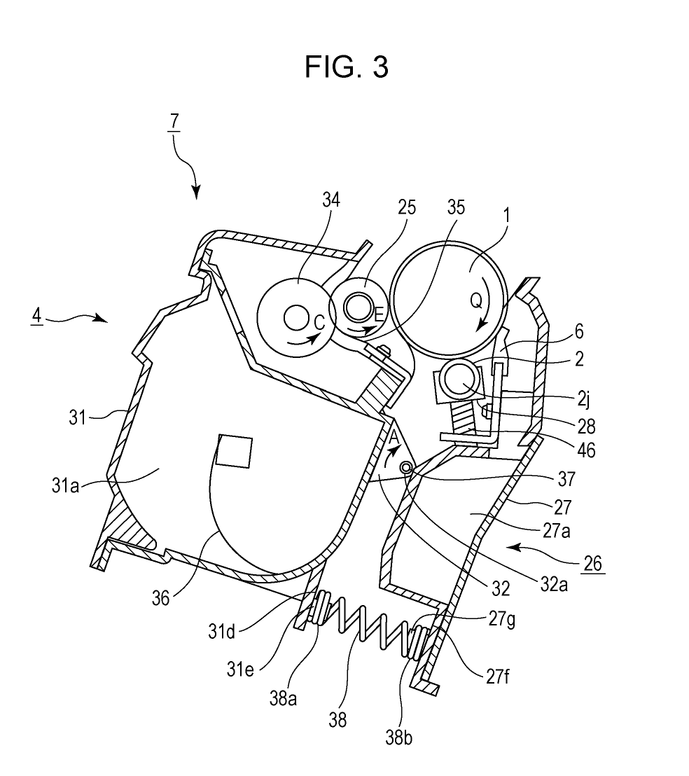

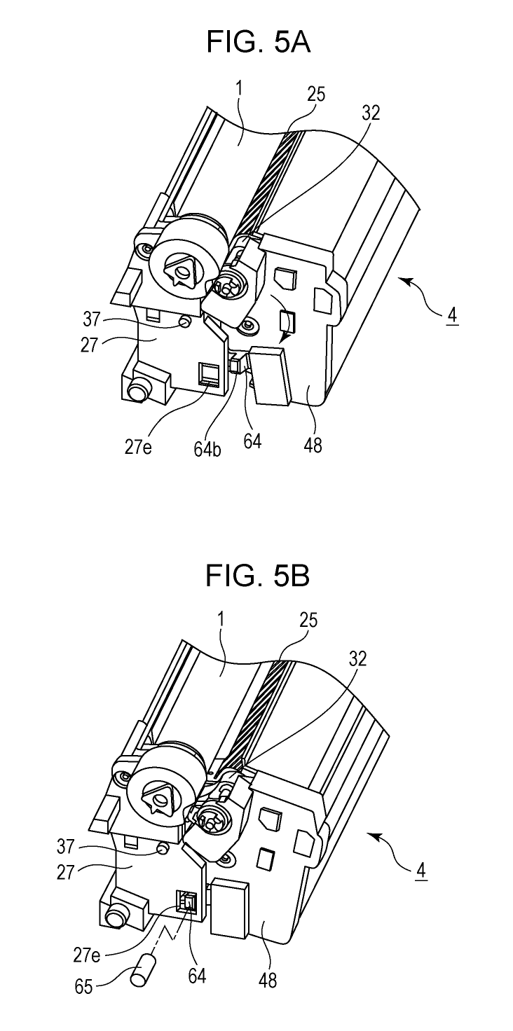

Referring to FIG. 3, and FIGS. 5A and 5B, the cartridge of the embodiment will be described. FIG. 3 is a main cross section illustrating the cartridge 7 (7a) having toner t contained therein. FIGS. 5A and 5B are partial perspective views illustrating the cartridge. The cartridge 7a in which the yellow toner t is contained, the cartridge 7b in which the magenta toner t is contained, the cartridge 7c in which the cyan toner t is contained, and the cartridge 7d in which the black toner t is contained have the same configuration. Therefore, in the following description, the cartridges 7a, 7b, 7c, and 7d are not distinguished between unless otherwise specifically required, and are collectively described as the cartridge 7.

The cartridge 7 is divided into a photosensitive unit 26 having the photosensitive drum 1, the charging roller (charging unit) 2, the cleaning member (cleaning unit) 6, and the developing unit 4 having a developing roller (developer carrying member) 25.

The photosensitive drum 1 is rotatably mounted on a cleaning frame body 27 of the photosensitive unit 26 via a carrying (not illustrated). Here, the cleaning frame body 27 is a first frame body of the cartridge 7, and is a frame body configured to rotatably support the photosensitive drum 1.

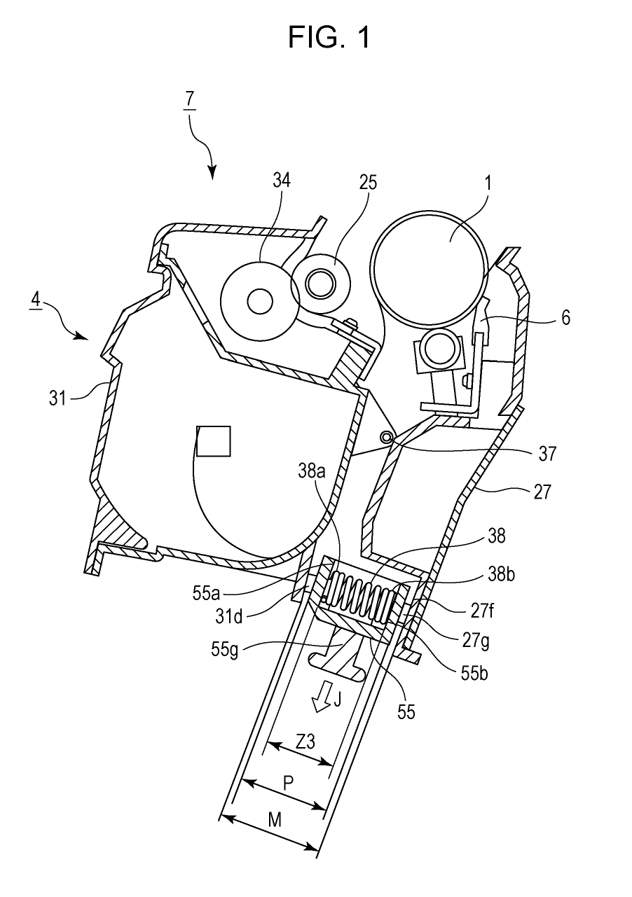

By transmitting a drive force from a drive member (not illustrated) provided on the apparatus body 100a (see FIG. 1) to the photosensitive unit 26, the photosensitive drum 1 is driven to rotate in the direction indicated by the arrow Q according to the image forming operation. As described above, the charging roller 2 and the cleaning member 6 are arranged on the periphery of the photosensitive drum 1.

The remaining toner removed from the surface of the photosensitive drum 1 by the cleaning member 6 drops into a removed toner chamber 27a in the interior of the cleaning frame body 27. A charging roller carrying 28 is mounted on the cleaning frame body 27. A shaft 2j of the charging roller 2 is rotatably mounted on the charging roller carrying 28. The carrying 28 is in a state of being pressed by a charge roller pressing member 46 against the photosensitive drum 1.

The developing unit 4 includes the developing roller 25 rotating in the direction indicated by the arrow E by coming into contact with the photosensitive drum 1 and a developing frame body 31. The developing frame body 31 is a second frame body of the process cartridge, and is a frame body configured to rotatably support the developing roller 25. In other words, the developing roller 25 is rotatably supported by the developing frame body 31 via carrying members 32 (see FIGS. 5A and 5B) mounted respectively on the two sides of the developing frame body 31 in the longitudinal direction. The developing roller 25 here is a developer carrying member configured to carry toner for developing a static latent image formed on the photosensitive drum 1.

A toner supply roller 34 configured to rotate in the direction indicated by the arrow C in contact with the developing roller 25 and a developing blade 35 configured to control the thickness of a toner layer formed on the developing roller 25 are arranged on the periphery of the developing roller 25. In a toner containing chamber 31a of the developing frame body 31, a toner transport member 36 configured to stir the toner contained therein and transport the toner to the toner supply roller 34 is provided.

Then, the developing frame body 31 of the developing unit 4 is coupled to the cleaning frame body 27 of the photosensitive unit 26 so as to be rotatable about a coupling pin 37 which is fitted into holes 32a provided on the carrying members 32. The developing unit 4 is urged by a pressing spring 38 (described later in detail).

### Configuration of Pressuring Spring

Subsequently, a configuration of the pressing spring 38 as an urging member for urging (pressing) the above-described developing roller 25 against the photosensitive drum 1 will be described in detail with reference to FIG. 3. The pressing spring 38 is a compression coil spring provided with wound seat portions 38a and 38b on the ends thereof. The developing frame body 31 is also provided with an engaging boss 31e and a spring seat surface 31d, and the cleaning frame body 27 is provided with an engaging boss 27g and a spring seat surface 27f.

The wound seat portion 38b at one end of the pressing spring 38 engages the engaging boss 27g of the cleaning frame body 27 and is in contact with the spring seat surface 27f. The wound seat portion 38a at the other end of the pressing spring 38 engages the engaging boss 31e of the developing frame body 31 and is in contact with the spring seat surface 31d.

Here, the engaging boss 27g is a projecting portion (first projecting portion) which enters a coil of the pressing spring 38 from the wound seat portion 38b and engages the wound seat portion 38b. Here, the engaging boss 31e is a projecting portion (second projecting portion) which enters the coil of the pressing spring 38 from the wound seat portion 38a and engages the wound seat portion 38a.

In this manner, as a result of the pressing spring 38 being supported by the cleaning frame body 27 and the developing frame body 31, the developing unit 4 rotates about the coupling pin 37 in the direction indicated by the arrow A by the urging force of the pressing spring 38, and the developing roller 25 is in contact with the photosensitive drum 1.

### Configuration for Mounting Cartridge on Image Forming Apparatus Body

Subsequently, a configuration for demountably mounting the cartridge 7 of the embodiment on the apparatus body of the image forming apparatus will be described with reference to FIG. 4.

FIG. 4 is a perspective view of the image forming apparatus for explaining a state before the cartridge 7 is mounted on the apparatus body 100a. In this embodiment, the cartridge 7 on the apparatus body 100a is configured so as to be insertable in the direction indicated by the arrow F, which is a direction parallel to the axial direction of the photosensitive drum 1, that is, from the near side to the far side in FIG. 4. Accordingly, the cartridge 7 may be mounted on and demounted from the apparatus body 100a.

In FIG. 4, a front cover 21 which is openable and closable is provided on the near side of the apparatus body 100a. When the front cover 21 is opened, the mounting portions 22a to 22d (which may be collectively referred to as 22 for the sake of simplicity of description) of the four cartridges 7a to 7d arranged in a line so as to be inclined with respect to the horizontal direction are exposed. Mounting upper guides 80a to 80d (which may be collectively referred to as 80 for the sake of simplicity of description) as first body-side guides and mounting lower guides 81a to 81d (which may be collectively referred to as 81 for the sake of simplicity of description) as second body-side guides extending from the near side to the far side of the apparatus body 100a are provided on the upper side and the lower side of the respective mounting portions 22a to 22d. Then, a guided portion (first cartridge-side guided portion) 29 provided on the photosensitive unit 26 of the cartridge 7 is engaged with the mounting upper guide 80 of the apparatus body 100a and pushed therein in the direction indicated by the arrow F. In the same manner, a guided portion (second cartridge-side guided portion) 30 provided on the photosensitive unit 26 is engaged with the mounting lower guide 81 of the apparatus body 100a and pushed thereto in the direction indicated by the arrow F.

The first guided portion 29 is arranged above the distal end side of the cartridge 7. The second guided portion 30 is arranged on a bottom surface of the cartridge 7 from the distal end side of the cartridge 7 toward the rear end.

The guided portion 29 and the guided portion 30 are arranged on the same side with respect to the photosensitive drum 1 in the direction orthogonal to an axial line of the photosensitive drum 1. Accordingly, stable advancement of the cartridge 7 into the image forming apparatus 100 is achieved.

Configuration for Keeping a Separated state between Photosensitive Drum and Developing Roller

Subsequently, a configuration for keeping a separated state between the photosensitive drum and the developing roller in the cartridge at the time of shipping will be described with reference to FIG. 5A to FIG. 7.

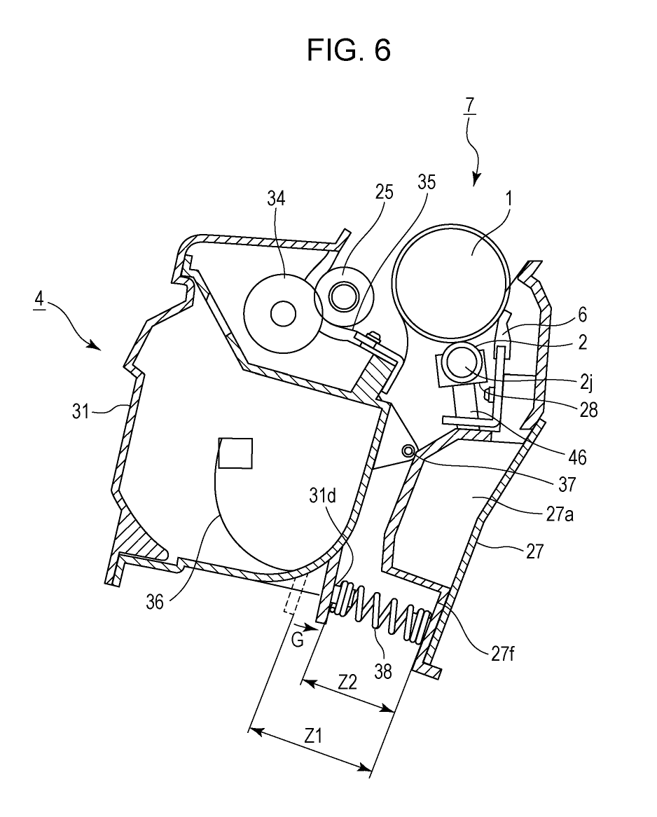

FIG. 5A is a partial perspective view illustrating the cartridge 7 in a state in which the developing roller 25 and the photosensitive drum 1 are in contact with each other. FIG. 5B is a partial perspective view illustrating the cartridge 7 in a state in which the developing roller 25 and the photosensitive drum 1 are separated from each other. FIG. 6 is a cross sectional view illustrating the cartridge 7 in the state in which the developing roller 25 and the photosensitive drum 1 are separated from each other.

As illustrated in FIG. 5A, a separation member (hereinafter, referred to as “separation keeping member”) 64 for keeping the photosensitive drum 1 and the developing roller 25 in a separated state is provided on the developing unit 4 of the cartridge 7. When the developing unit 4 is rotated in the direction indicated by the arrow B about the coupling pin 37, the developing roller 25 moves away from the photosensitive drum 1. By engaging the separation keeping member 64 with a hole 27e provided on a side surface of the cleaning frame body 27 in a state in which the developing roller 25 is separated, the developing roller 25 is held in a posture separated from the photosensitive drum (see FIG. 5B).

At this time, since the spring seat surface 31d of the developing frame body 31 moves in the direction indicated by the arrow G by the rotation of the developing unit 4 as illustrated in FIG. 6, the working length of the pressing spring 38 has a length (working length) Z2 shorter than a working length Z1 at the time of normal image formation.

Subsequently, a configuration for releasing the above-described separated state will be described. As illustrated in FIG. 5B, a body release portion 65 which comes into contact with the separation keeping member 64 is provided on the apparatus body 100a of the image forming apparatus. When the cartridge 7 is mounted on the apparatus body 100a, the body releasing portion 65 comes into contact with the separation keeping member 64, moves the separation keeping member 64 in the longitudinal direction of the process cartridge 7 using a mounting force applied when the cartridge 7 is mounted to release the separated state.

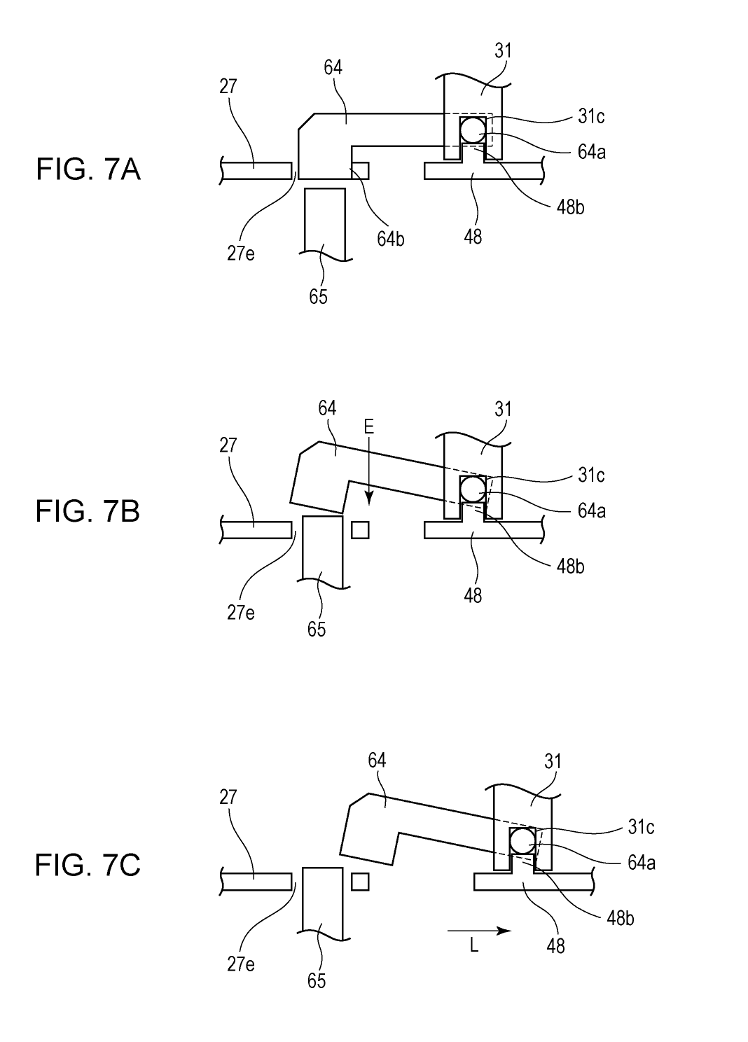

The method of releasing the separation keeping member 64 will further be described with reference to FIGS. 7A, 7B, and 7C. FIG. 7A illustrates a boss 64a provided on the separation keeping member 64. The boss 64a is rotatably supported by a groove 31c provided on the developing frame body 31, and is pressed by a holding portion 48b of a side cover 48 mounted on the developing frame body 31. An engaging portion 64b of the separation keeping member 64 is in a state of being engaged with the hole 27e provided on the cleaning frame body 27. When the cartridge 7 is moved in the direction indicated by the arrow E in this state, the body releasing portion 65 is inserted into the hole 27e of the cleaning frame body 27 as illustrated in FIG. 7B. Then, the body releasing portion 65 comes into contact with the separation keeping member 64, and releases the separation keeping member 64 from the cleaning frame body 27.

Then, as illustrated in FIG. 7C, the developing frame body 31 is allowed to move in the direction indicated by the arrow L so as to allow the photosensitive drum 1 and the developing roller 25, not illustrated, to come into contact with each other.

By using the separation keeping member 64, the developing unit 4 may be held at the separated position in FIG. 5B (the position where the developing roller 25 is separated from the photosensitive drum 1) before used by the users. In this configuration, deformation of the developing roller 25 by being continuously pressed against the photosensitive drum 1 for a long time is restraining so that an effect of restraining the influence of the deformation of the developing roller 25 on the image quality is achieved.

### Configuration of Pressuring Spring Holding Member

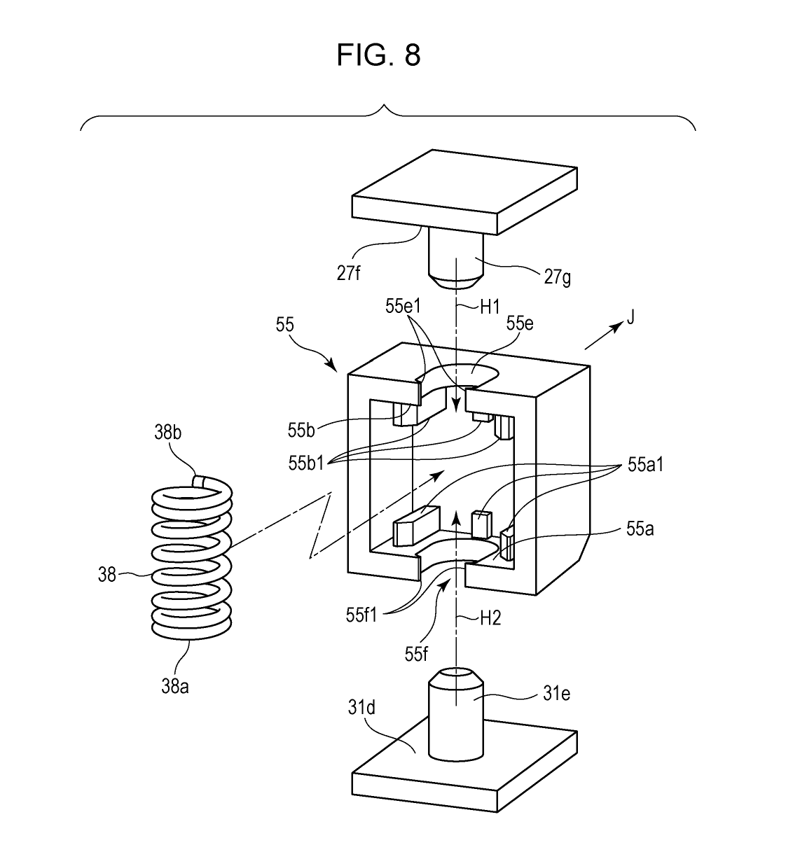

Referring now to FIG. 1, FIG. 6, and FIG. 8, a pressing spring holding member 55 which is a characteristic configuration of this embodiment will be described. In this embodiment, a case where the pressing spring holding member 55 is provided on one end portion of the cartridge 7 on the downstream side in the direction of mounting of the body is described for the sake of convenience. However, the same configuration may be used at both end portions of the cartridge 7.

FIG. 1 is a cross-sectional view illustrating a state in which the pressing spring holding member 55 is mounted on the cartridge 7, and FIG. 8 is an explanatory drawing illustrating a configuration of the pressing spring holding member 55.

As described above, when the separation keeping member 64 (see FIGS. 5A and 5B) is engaged with the cleaning frame body 27 and the photosensitive drum 1 and the developing roller 25 are separated at the time of shipping of the cartridge 7, the pressing spring 38 is brought into a state of being compressed more than at the time of normal image forming. In other words, the working length Z2 of the pressing spring 38 becomes shorter than the working length Z1 at the time of image forming.

Therefore, the spring seat surface 27f of the cleaning frame body 27 as a contact portion with respect to the pressing spring 38 and the spring seat surface 31d of the developing frame body 31 receive the urging force larger than at the time of normal image forming from the pressing spring 38. Suppose the cartridge 7 is shipped in this state and this state is maintained for a long time until the cartridge 7 is mounted on the apparatus body 100a of the image forming apparatus, deformation may be generated on the spring seat surfaces 27f and 31d and the portion in the vicinity thereof due to the urging force of the pressing spring 38. Therefore, in this case, a countermeasure such as enhancing the stiffness of the seat surfaces 27f and 31d is additionally required.

Accordingly, this embodiment is characterized in that the pressing spring holding member 55 which is capable of holding the both ends (wound seat portions 38a and 38b) of the pressing spring 38 instead of the seat surfaces 27f and 31d is provided. Here, the pressing spring holding member 55 is a holding member configured to hold the pressing spring 38 so as not to allow the pressing spring 38 to apply the urging force to the cleaning frame body 27 and the developing frame body 31. Detailed description is given below.

As illustrated in FIG. 8, the pressing spring holding member 55 is formed into a box shape having receiving surfaces 55b and 55a capable of coming into contact with the wound seat portions 38b and 38a of the compressed pressing spring 38.

The receiving surface 55b corresponds to a contact portion (first contact portion) configured to receive an urging force of the pressing spring 38 by coming into contact with the wound seat portion 38b corresponding to one end portion of the pressing spring 38. The receiving surface 55a corresponds to a contact portion (second contact portion) configured receive an urging force of the pressing spring 38 by coming into contact with the wound seat portion 38b corresponding to the other end portion of the pressing spring 38. The receiving surfaces 55a and 55b are provided with guide portions 55a1 and 55b1 and engaging grooves 55f and 55e.

The guide portions 55a1 and 55b1 define the position of the pressing spring 38 by coming in contact with the wound seat portions 38a and 38b of the pressing spring 38 respectively when the pressing spring 38 is inserted into the interior of the pressing spring holding member 55 from the direction indicated by the arrow K in the drawing.

The engaging groove 55e is a groove portion (first groove portion) having a resiliently deformable claw-shaped locking portion 55e1 at a distal end thereof. When the engaging boss 27g provided on the cleaning frame body 27 enters the engaging groove 55e, the locking portion 55e1 locks the engaging boss 27g, whereby the engaging groove 55e and the engaging boss 27g engage.

The engaging groove 55f is a groove portion (second groove portion) having a similar shape to the engaging groove 55e. In other words, a resiliently deformable claw-shaped locking portion 55f1 is provided at a distal end thereof, and when the engaging boss 31e provided on the developing frame body 31 enters the engaging groove 55f, the engaging groove 55f engages the engaging boss 31e. The engagement of the engaging grooves 55e and 55f and the engaging bosses 27g and 31e will be described in detail.

When mounting the pressing spring holding member 55 on the cartridge 7, the pressing spring 38 in the compressed state is inserted into the pressing spring holding member 55 from the direction indicated by the arrow K and the position of the pressing spring 38 is defined by the guide portions 55a1 and 55b1.

Then, the pressing spring holding member 55 in the state in which the pressing spring 38 is mounted is inserted between the spring seat surface 27f of the cleaning frame body 27 and the spring seat surface 31d of the developing frame body 31. Then, the spring seat surface 27d is moved in the direction indicated by the arrow H1 by rotating the cleaning frame body 27 about the coupling pin 37 (see FIG. 1), and the engaging boss 27g is inserted into the engaging groove 55e and the wound seat portion 38b. Also, the spring seat surface 31d is moved in the direction indicated by the arrow H2 by rotating the developing frame body 31 about the coupling pin 37 (see FIG. 1), and the engaging boss 31e is inserted into the engaging groove 55f and the wound seat portion 38b.

Accordingly, the engaging groove 55e of the pressing spring holding member 55 and the wound seat portion 38b of the pressing spring 38 engage the engaging boss 27g of the cleaning frame body 27. Also, the engaging groove 55f and the wound seat portion 38a engage the engaging boss 31e of the developing frame body 31. In this manner, the pressing spring holding member 55 is mounted on the cartridge 7 as illustrated in FIG. 1.

The photosensitive drum 1 and the developing roller 25 are kept in the separated state by engaging the separation keeping member 64 (see FIGS. 5A and 5B) with the hole 27e of the cleaning frame body 27 after the pressing spring holding member 55 is mounted on the cartridge 7.

Since the pressing spring holding member 55 receives the urging force of the pressing spring 38 instead of the developing frame body 31 and the cleaning frame body 27, deformation of the developing frame body 31 and the cleaning frame body 27 by the pressing spring 38 may be restrained.

The distance between the receiving surface 55a and the receiving surface 55b is kept to be shorter than the natural length of the pressing spring 38. Therefore, when the pressing spring 38 is held by the pressing spring holding member 55, the pressing spring 38 is compressed in a state in which both ends thereof are in contact with the receiving surface 55a and the receiving surface 55b, and a working length Z3 is smaller than a distance M between the spring seat surface 27f and the spring seat surface 31d. Also, an outer distance P of the pressing spring holding member 55 configured to hold the pressing spring 38 is also smaller than the distance M between the spring seat surface 27f and the spring seat surface 31d. In other words, Z3<P<M is satisfied.

The pressing spring holding member 55 is configured to reliably receive the urging force of the pressing spring 38, and hence is capable of having higher stiffness than the cleaning frame body 27 and the developing frame body 31. Therefore, in this embodiment, HIPS having a bending elastic modulus of 2300 MPa was used for the cleaning frame body 27 and the developing frame body 31, and PC-ABS having a bending elastic modulus of 3000 MPa was used for the pressing spring holding member 55. In other words, the pressing spring holding member 55 was formed of a material having a bending elastic modulus larger than that of the cleaning frame body 27 and the developing frame body 31.

### Method of Removing Spring Holding Member

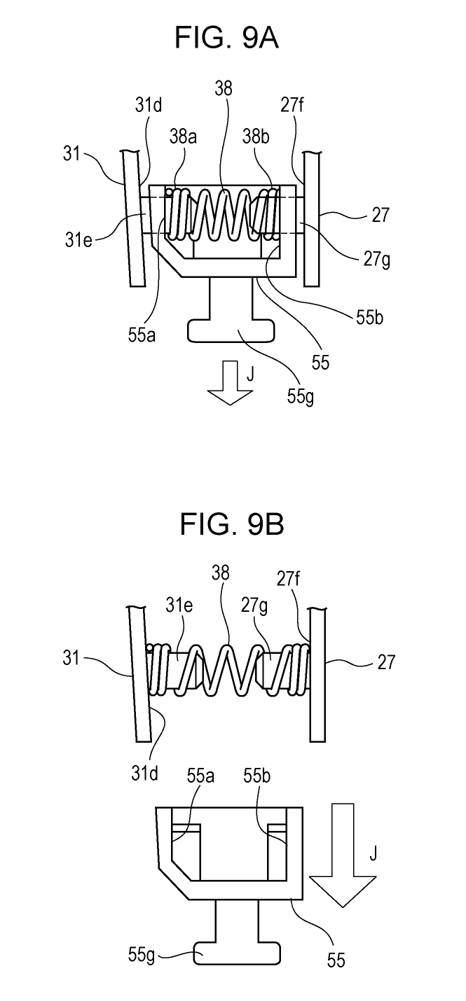

Subsequently, a configuration for removing the pressing spring holding member 55 from the cartridge 7 will be described with reference to FIGS. 9A and 9B and FIG. 8. FIG. 9A is a partial cross-sectional view illustrating the cartridge when the pressing spring holding member is mounted, and FIG. 9B is a partial cross-sectional view illustrating the cartridge when the pressing spring holding member is removed.

In this embodiment, the pressing spring holding member 55 is provided with a grip portion 55g as illustrated in FIGS. 9A and 9B. When the user grips the grip portion 55g and pulls the same in the direction indicated by the arrow J before mounting the cartridge 7 on the apparatus body 100a of the image forming apparatus, the locking portion 55e1 (see FIG. 8) provided on the pressing spring holding member 55 is deformed, whereby the engaging boss 27g is removed from the engaging groove 55e. By the deformation of the locking portion 55f1 (see FIG. 8), the engaging boss 31e is removed from the engaging groove 55f. Accordingly, engagement of the engaging groove 55e and the engaging groove 55f with the engaging boss 27g of the cleaning frame body 27 and the engaging boss 31e of the developing frame body 31 is released, so that the pressing spring holding member 55 may be removed from the cartridge 7.

At that time, since the pressing spring 38 keeps the state of engagement between the wound seat portions 38a and 38b and the engaging bosses 27g and 31e, the pressing spring 38 does not move with the pressing spring holding member 55. As illustrated in FIG. 9B, the wound seat portions 38a and 38b of the pressing spring 38 are separated from the receiving surfaces 55a and 55b of the pressing spring holding member 55 respectively. Then, the pressing spring 38 released from the contact with the receiving surfaces 55a and 55b expands from the compressed state and causes the wound seat portions 38a and 38b at both ends of the pressing spring 38 to be seated on the spring seat surfaces 27f and 31d provided on the cleaning frame body 27 and the developing frame body 31.

Subsequently, by releasing the engagement of the separation keeping member 64 (see FIG. 5) with the cleaning frame body 27, the developing unit 4 rotates with respect to the photosensitive unit 26 about the coupling pin 37 (see FIG. 3) by the urging force of the pressing spring 38. In other words, the developing unit 4 rotates in the direction indicated by the arrow A3 illustrated in FIG. 3 to bring the developing roller 25 into contact with the photosensitive drum 1.

The pressing spring holding member 55 as described above prevents the urging force of the pressing spring 38 from being applied to the developing frame body 31 and the cleaning frame body 27 by keeping the compressed pressing spring 38 in the state of being mounted between the developing frame body 31 and the cleaning frame body 27. Accordingly, before the usage of the cartridge 7, the spring seat surface 31d of the developing frame body 31 and the spring seat surface 27f of the cleaning frame body 27 may be prevented and restrained from being deformed by the urging force of the pressing spring 38. Therefore, when the pressing spring holding member 55 is removed from the cartridge 7 in order to use the cartridge 7 for the image forming, the urging force of the pressing spring 38 is made to be applied reliably to the spring seat surface 27f and the spring seat surface 31d, and the pressure is applied to the developing roller 25 (see FIG. 3) stably against the photosensitive drum 1.

When the pressing spring holding member 55 is mounted on the cartridge 7, the urging force of the pressing spring 38 is not applied to the developing frame body 31 and the cleaning frame body 27, so that the pressure is not applied to the developing roller 25 supported by the developing frame body 31 against the photosensitive drum 1. Therefore, deformation of the developing roller 25 by the force pressed by the photosensitive drum 1 may be restrained. Specifically, in this embodiment, the separation keeping member 64 (see FIG. 5) is engaged with the cleaning frame body 27 in the state in which the pressing spring holding member 55 is mounted on the cartridge 7 and the state in which the developing roller 25 and the photosensitive drum 1 are separated from each other is maintained. Even though an impact is applied to the cartridge 7 during the commodity distribution, the developing roller 25 and the photosensitive drum 1 do not come into contact with each other, so that deformation and breakage of the developing roller 25 and the photosensitive drum 1 may restrained more reliably.

In this embodiment, the removal of the pressing spring holding member 55 from the cartridge is performed by the user. However, a configuration in which the pressing spring holding member 55 is removed from the cartridge 7 in conjunction with the operation of mounting the cartridge 7 on the apparatus body 100a in the same manner as the configuration of releasing the separated state between the photosensitive drum 1 and the developing roller 25 by the separation keeping member 64.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-280102, filed Dec. 21, 2011, which is hereby incorporated by reference herein in its entirety.

What is claimed is:

1. A process cartridge demountably mountable on an apparatus body of an image forming apparatus comprising:
an image carrying member on which a static latent image is formed;
a first frame body configured to support the image carrying member;
a developer carrying member configured to carry developer;
a second frame body rotatably coupled to the first frame body and configured to support the developer carrying member;
an urging member configured to apply an urging force to the first frame body and the second frame body so as to urge the developer carrying member against the image carrying member;
a holding member demountably mounted between the first frame body and the second frame body, the holding member including a first contact portion coming into contact with one end portion of the urging member and a second contact portion coming into contact with the other end portion of the urging member and configured to hold the urging member so as not to cause the urging member to apply the urging force to the first frame body and the second frame body, wherein
the urging member is configured to apply the urging force to the first frame body and the second frame body upon removal of the holding member.

2. The process cartridge according to claim 1, wherein the urging member is a spring and the length of the urging member held by the holding member is shorter than the length of the urging member when the holding member is removed.

3. The process cartridge according to claim 2, wherein the urging member brings the one end portion and the other end portion into contact with the first frame body and the second frame body respectively to apply the urging force to the first frame body and the second frame body when the holding member is removed from between the first frame body and the second frame body.

4. The process cartridge according to claim 1, wherein the holding member includes a first groove portion formed on the first contact portion and a second groove portion formed on the second contact portion, and
the process cartridge further includes:
a first projecting portion provided on the first frame body so as to enter the first groove portion and engage the one end portion of the urging member; and
a second projecting portion provided on the second frame body so as to enter the second groove portion and engage the other end portion of the urging member.

5. The process cartridge according to claim 3, wherein the urging member is a coil spring, and
the first projecting portion engages the one end portion of the urging member by entering the interior of the coil of the urging member, and the second projecting portion engages the other end portion of the urging member by entering the interior of the coil of the urging member.

6. The process cartridge according to claim 4, wherein at least one of the first groove portion and the second groove portion includes a locking portion for engaging the first projecting portion or the second projecting portion, and the engagement between the first groove portion and the first projecting portion or the engagement between the second groove portion and the second projecting portion is released by deformation of the locking portion when the holding member is removed.

7. The process cartridge according to claim 1, further comprising:
a separating member configured to keep a state in which the image carrying member and the developer carrying member are separated from each other in a state in which the holding member is mounted.

8. The process cartridge according to claim 1, wherein the holding member is formed of a material having a bending elastic modulus larger than that of the first frame body and the second frame body.

9. The process cartridge according to claim 1, wherein the holding member includes a grip portion to be gripped by a user, and the holding member is configured to be removed by pulling the grip portion.

10. The process cartridge according to claim 1, wherein the holding member is removed in conjunction with mounting of the process cartridge on the apparatus body of the image forming apparatus.

11. An image forming apparatus configured to form an image on a recording medium comprising:
a transport device configured to transport the recording medium; and
a process cartridge demountably mountable on an apparatus body of the image forming apparatus, wherein the process cartridge includes:
an image carrying member on which a static latent image is formed;
a first frame body configured to support the image carrying member;
a developer carrying member configured to carry developer;
a second frame body rotatably coupled to the first frame body and configured to support the developer carrying member;
an urging member configured to apply an urging force to the first frame member and the second frame member so as to urge the developer carrying member against the image carrying member;
a holding member demountably mounted between the first frame member and the second frame member, the holding member including a first contact portion coming into contact with one end portion of the urging member and a second contact portion coming into contact with the other end portion of the urging member and configured to hold the urging member so as not to cause the urging member to apply the urging force to the first frame member and the second frame member, wherein
the urging member is configured to apply the urging force to the first frame member and the second frame member upon removal of the holding member.

12. The image forming apparatus according to claim 11, wherein the urging member is a spring and the length of the urging member held by the holding member is shorter than the length of the urging member when the holding member is removed.

13. The image forming apparatus according to claim 12, wherein the urging member brings the one end portion and the other end portion into contact with the first frame member and the second frame member respectively to apply the urging force to the first frame member and the second frame member when the holding member is removed from between the first frame body and the second frame body.

14. The image forming apparatus according to claim 11, wherein the holding member includes a first groove portion formed on the first contact portion and a second groove portion formed on the second contact portion, and
the process cartridge further includes:
a first projecting portion provided on the first frame body so as to enter the first groove portion and engage the one end portion of the urging member;
a second projecting portion provided on the second frame body so as to enter the second groove portion and engage the other end portion of the urging member.

15. The image forming apparatus according to claim 14, wherein the urging member is a coil spring, and
the first projecting portion engages the one end portion of the urging member by entering the interior of the coil of the urging member, and the second projecting portion engages the other end portion of the urging member by entering the interior of the coil of the urging member.

16. The image forming apparatus according to claim 14, wherein at least one of the first groove portion and the second groove portion includes a locking portion for engaging the first projecting portion or the second projecting portion, and the engagement between the first groove portion and the first projecting portion or the engagement between the second groove portion and the second projecting portion is released by deformation of the locking portion when the holding member is removed.

17. The image forming apparatus according to claim 11, wherein the process cartridge further includes:
a separating member configured to keep a state in which the image carrying member and the developer carrying member are separated from each other in a state in which the holding member is mounted.

18. The image forming apparatus according to claim 11, wherein the holding member is formed of a material having a bending elastic modulus larger than that of the first frame body and the second frame body.

19. The image forming apparatus according to claim 11, wherein the holding member includes a grip portion to be gripped by a user, and the holding member is configured to be removed by pulling the grip portion.

20. The image forming apparatus according to claim 11, wherein the holding member is removed in conjunction with mounting of the process cartridge on the apparatus body of the image forming apparatus.
